(19) United States
(12) Patent Application Publication
(10) Pub. No.: US 2025/0248349 A1
(43) Pub. Date: Aug. 7, 2025

(54) CAPSULE AND METHOD FOR PROVIDING NUTRIENTS TO A TREE

(71) Applicant: David MORIN, Saint-Felix-de-Valois (CA)

(72) Inventor: David MORIN, Saint-Felix-de-Valois (CA)

(21) Appl. No.: 19/038,996

(22) Filed: Jan. 28, 2025

Related U.S. Application Data
(60) Provisional application No. 63/627,982, filed on Feb. 1, 2024.

(51) Int. Cl. A01G 29/00

(52) U.S. Cl. CPC A01G 29/00

(57) ABSTRACT

A capsule designed for being inserted in a ground proximate a tree for providing nutrients to the tree through its roots comprises a hollow body with a closed end and an opposite open end. The body of the capsule has a container portion proximate the closed end and a distribution portion with at least one perforation between the container portion and the open end. The capsule is inserted closed end first in the ground and nutrients are placed in the container portion of the capsule so that roots of the tree can reach the nutrients through the perforation.

### CROSS-REFERENCE TO RELATED APPLICATIONS

This application claims priority to U.S. Provisional Application No. 63/627,982 filed on Feb. 1, 2024, which is hereby incorporated by reference in its entirety.

### FIELD OF THE INVENTION

The present invention generally relates to the field of accessories for improving the health of trees. More specifically, the invention relates to a capsule for being inserted in a ground proximate a tree for providing nutrients to the tree through its roots. An associated method for providing the nutrients to trees is also provided.

### BACKGROUND OF THE INVENTION

Trees, especially in urban environment, have difficulty to grow healthy because the ground surrounding them is dense, lacks organic material, lacks free space for roots and depleted from nutrients. Cities alleviate this problem by injecting trees with the required nutrients. However, this operation takes time and is expensive.

There is therefore a need for a better device and method to provide trees, especially in urban environment, with the nutrients they require to grow and stays healthy.

### SUMMARY OF THE INVENTION

It is an object of the present invention to provide a capsule and method for providing nutrients to a tree that overcomes or mitigates one or more disadvantages of known capsules or methods, or at least provides a useful alternative.

The invention provides the advantages of being adapted to gradually making nutrients available to a tree and of being easily accessible to be reloaded with nutrients.

In accordance with an embodiment of the present invention, there is provided a capsule for being inserted in a ground proximate a tree for providing nutrients to the tree through its roots. The capsule comprises a hollow body and a cover. The hollow body has a closed end and an opposite open end. The hollow body has a container portion proximate the closed end and a distribution portion between the container portion and the open end. The container portion has a solid container wall while the distribution portion has a lateral distribution wall with at least one perforation. The cover is removably connected to the open end for selectively closing the open end. When the capsule is inserted closed end first in the ground, the container portion is operable to receive the nutrients inserted through the open end. The nutrients are accessible to the roots of the tree through the at least one perforation. The cover is operable to close the open end of the hollow body once the nutrients are contained in the container portion, thereby preventing removal of the nutrients.

Optionally, the hollow body may be cylindrical and its closed end may be conical.

The container portion may extend between 10% and 75% of the height of the hollow body, or between 10% and 50% of the height.

There may be fewer than 20 perforations. Each perforation may be between 7.9 mm ( 7/16 in) and 75.2 mm (3 in) in diameter.

The hollow body may further comprise a thread running at least partially on an exterior of at least one of the solid container wall and the lateral distribution wall.

The cover may be lockable to the hollow body. The cover may also be decorated with an aesthetic design on a top face thereof. This top face is opposite to the closed end when the cover is installed on the hollow cylindrical body. The cover may be provided with an aperture in the top face to let rainwater accumulate in the container portion.

In accordance with another embodiment, there is provided a method for providing nutrients to a tree. The method comprises:
a) inserting the capsule for providing nutrients to a tree in a ground proximate the tree so that the closed end is inserted first and so that the open end is proximate a surface of the ground;
b) placing the nutrients in the container portion; and
c) providing roots of the tree access to the nutrients through the at least one perforation located in the ground above the container portion.

The method may comprise adding a solid mix to the capsule.

The method may comprise impregnating the solid mix with the nutrients.

Optionally, prior to the impregnating, the method may comprise diluting the nutrients with gelatin and humic acid in water to create a solution.

Optionally, the method may comprise replenishing the container portion with additional nutrients.

In accordance with yet another embodiment of the invention, there is provided a method for improving health of a tree planted in a ground. The method comprises providing roots of the tree access to nutrients placed in the container portion of the capsule for providing nutrients to a tree as disclosed through the at least one aperture. The capsule is inserted in the ground so that the at least one aperture is placed above the container portion. Optionally, method may comprise adding a solid mix to the capsule. The method may comprise impregnating the solid mix with the nutrients. Optionally, prior to the impregnating, the method may comprise diluting the nutrients with gelatin and humic acid in water to create a solution. The method may also comprise replenishing the container portion with additional nutrients.

### BRIEF DESCRIPTION OF DRAWINGS

These and other features of the present invention will become more apparent from the following description in which reference is made to the appended drawings wherein:

FIG. 1 is an isometric view from the front and top of a capsule for containing nutrients in accordance with an embodiment of the present invention;

FIG. 2 is a cross-sectional view of the capsule of FIG. 1;

FIG. 3 is a schematic view of the capsule of FIG. 1 inserted in the ground next to a tree;

FIG. 4 is front view of a capsule provided with a thread in accordance with another embodiment of the invention; and

FIG. 5 is an isometric view from the front and top of a capsule for containing nutrients in accordance with another embodiment of the present invention.

### DETAILED DESCRIPTION OF THE INVENTION

The present invention relates to a capsule and associated method for providing nutrients to a tree.

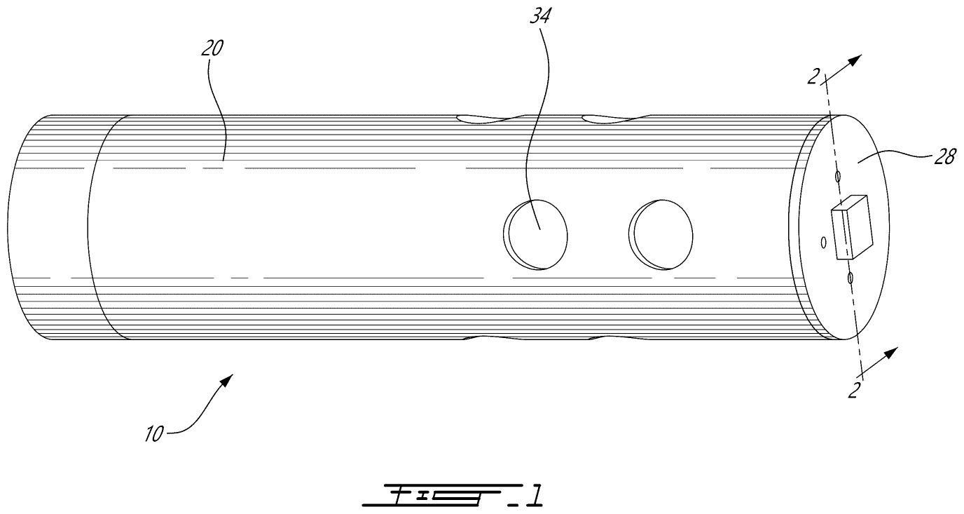

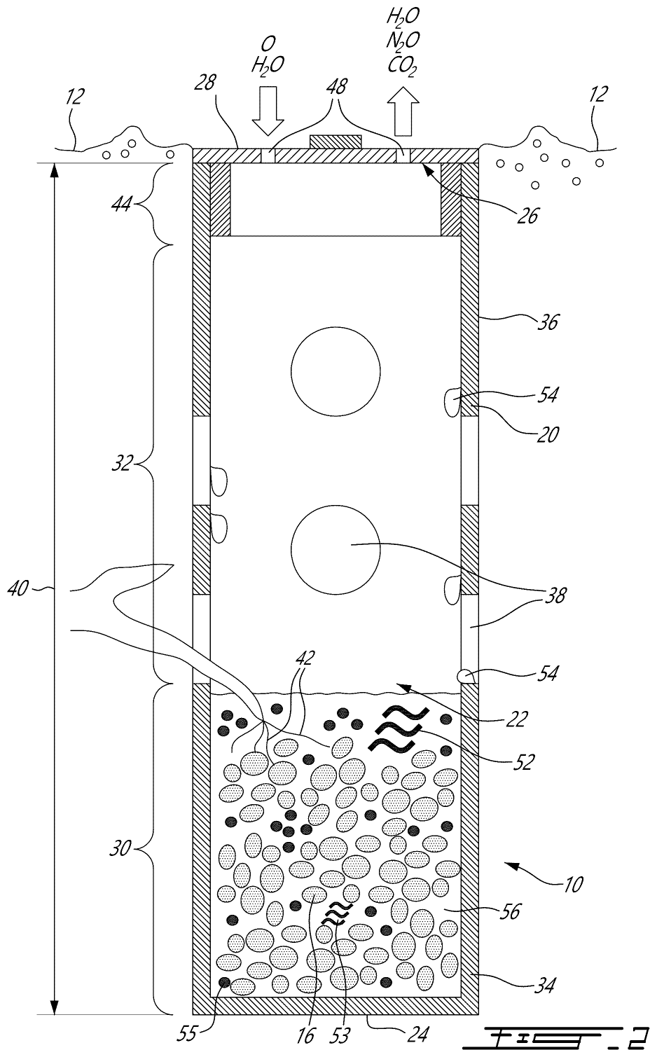

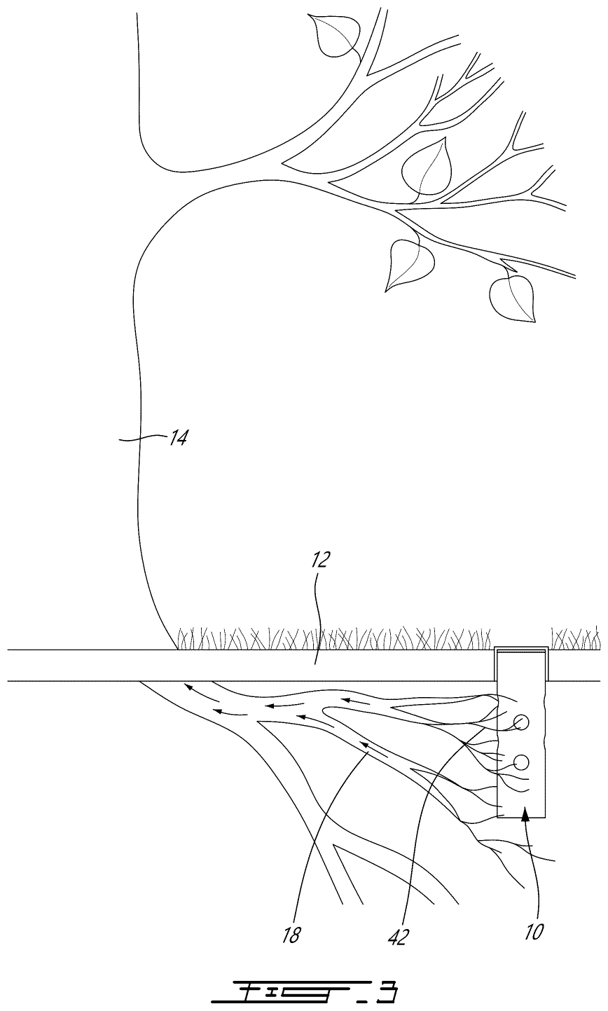

FIGS. 1, 2 and 3, concomitantly referred to, depict a capsule 10 designed to be inserted in a ground 12 proximate a tree 14 for providing nutrients 16 contained in the capsule 10 to the tree 14 through its roots 18. The capsule 10 has a hollow body 20 having a cavity 22 for storing the nutrients 16. The body 20 has a closed end 24 and an opposite open end 26. The nutrients 16 may be added in the cavity 22 of the body 20 through this open end 26 by removing a cover 28.

The body 20 has a reservoir or container portion 30 proximate the closed end 24 and a distribution portion 32 located between the container portion 30 and the open end 26. The container portion 30 has a solid container wall 34 which is devoid of any apertures or opening. Moreover, container wall 34 is also preferably impervious to liquid, solid and/or gaseous exchange through it. The container portion 30 may typically extend between 5% and 75% of the total height 40 of the body 20, or between 10% and 50% of the height 40. The container portion 30 is designed to receive the nutrients 16 inserted through the open end 26. The container portion 32 is also designed to retain water such as rain water. Having a solid wall in the container portion 32 while having a perforated wall in the distribution portion allows retaining nutrients placed in the capsule 10, thereby stimulating fine roots of the nearby tree 14 to grow in order to reach the nutrients placed within the capsule 10.

The distribution portion 32 has a lateral distribution wall 36 that is provided with at least one perforation 38. There may be any number of perforations, but typically a smaller number of larger perforations is preferred. The one or more perforation 38 is sized to be sufficiently large to allow the fine roots 42 of the tree 14 to enter capsule 10 and reach the nutrients 16 in the container portion 30. Each perforation 38 is typically between 7.9 mm ( 7/16 in) and 75.2 mm (3 in) in diameter, depending on the diameter of the capsule 10. For example, in a non-limiting example, there may be either 100 perforations or less of 7.9 mm ( 7/16 in), 30 perforations or less of 25.4 mm (1 in), 10 perforations or less of 57.2 mm (2 in), or 6 perforations or less of 60.3 mm (2.375 in). A top portion 44 of the body 20 is typically left devoid of perforations 38, or plain, as there is no need for them very close to the surface of the ground 12 since the fine roots 42 to which the capsule 10 caters are located slightly underneath the surface. For example, the top portion 44 may be approximately 63.5 mm (2.5 in) in height.

The body 20 is typically of approximately 406.4 mm (16 in) in height 40. The body 20 can be higher or shorter, but does not really need to be higher because it is designed to feed the nutrients 16 to the fine roots 42 which typically remain closer to the surface of the ground 12. The diameter of the body 20 typically ranges between 76.2 mm (3 in) and 152.4 mm (6 in). The number of perforations 38 must be adjusted according to the diameter and height of the body 20. The body 20 is made of a material that is not degraded rapidly in the ground. For example, the body 20 may be made of plastic, aluminum or stainless steel.

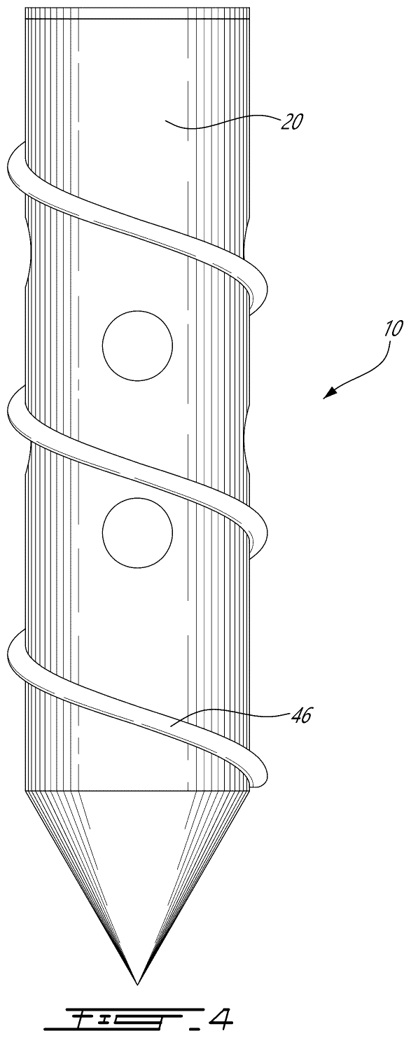

Preferably, the body 20 is cylindrical in shape, which makes it straightforward to insert in a hole in the ground. The body 20 may be provided with a conical-shaped closed end 24. FIG. 4 is now concurrently referred to. To prevent easy removal of the capsule 10 from the ground, for example when the capsule is installed in a urban environment, the body 20 may be provide with a thread 46, similar although larger to that of a screw. The thread 46 runs at least partially on the exterior of the body 20, more particularly on the exterior of at least one of the solid container wall 34 and the lateral distribution wall 36.

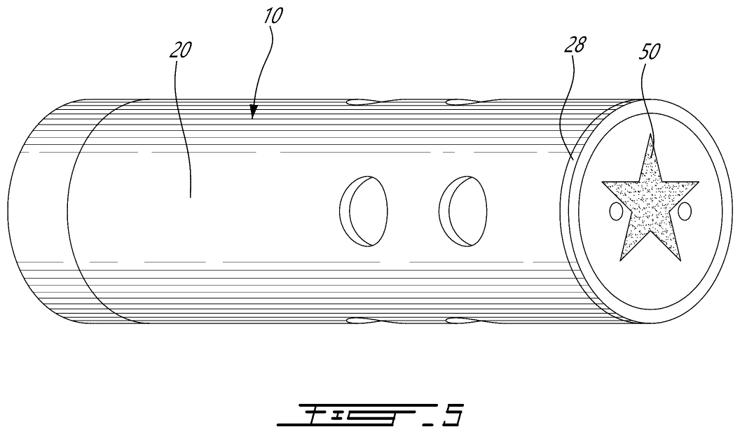

The cover 28 is removably connected to the open end 26 of the body 20 for selectively closing the open end 28. The cover 28 may be screwed to the body 20 or attached in any known convenient way. To prevent theft, the cover 28 may be locked to the body 20. When the body 20 is provided with the one or more thread 46 and the cover 46 is lockable on the body 20, it makes a capsule 10 which is better adapted for a urban environment where vandalism is typically more common. The cover 28 may be provided with holes 48 to allow oxygenation of the ground. The cover may be lockable to the hollow body. As shown in FIG. 5, now concurrently referred to, the cover 28 may be decorated with an aesthetic design 50 on a top face thereof, thereby providing a visually pleasant decoration. The aesthetic design 50 may also comprise useful information, such as the type of tree, when it was planted, or a tree and capsule reference code for management by the city responsible for caring for the trees.

The nutrients 16 typically consists of a mix of organic matter such as manure, and a fertilizer containing potassium, phosphorus and nitrogen. Different dosages may be used. The following dosage has been found to provide satisfactory results:
Nitrogen: 46
Phosphorus: 52
Potassium: 34

The NPK (Nitrogen (N), Phosphorus (P) and Potassium (K) numbers indicate the ratio of each element included in the fertilizer. In the present case, it has been found that the ratio 46-52-34 provides satisfying results. Other ratios may provide satisfactory results as well.

To conveniently convey these elements to the capsule 10, the elements are mixed with gelatin powder and humic acid in water to create a solution 53. The gelatin powder stabilizes water content and allows the nutrients 16 to be released gradually as the gelatin is decomposed over time. The humic acid accelerates this decomposition, transforming the environment in a viable rhizosphere. Such a solution 53 allows a slow release of a relatively highly concentrated mix of nutrients 16, which advantageously requires less recharging of the capsule 10 over time. Alternatively, it is possible to use a solution 53 having a lower concentration of nutrients 16. For example, a 20-20-20 dosage having:
Nitrogen: 20
Phosphorus: 20
Potassium: 20
   could also provide satisfactory results. However, such solutions with lower concentration of nutrient require more frequent recharges of the capsule 10, adding maintenance costs.

In a non-limiting example, the elements are mixed according to the following recipe: a soluble concentrate having 30 ml of nitrogen (N) and 60 ml of potassium phosphate (K₃PO₄) is diluted with 500 grams of gelatin powder in 25 liters of water. 250 ml of humic acid is then added to the mix. This creates an example of a possible solution 53.

The solution 53 may then be added to a solid mix 55, such as a composition of organic and clay elements, bacteria (such as Rhizobium) and fungi such as mycorrhizal fungi. This creates an impregnated mix 56, comprising both the solid mix and the solution. The impregnated mix 56 is then placed in the capsule 10. This typically occurs the first time the capsule 10 is used, either once, or prior to, the moment it gets inserted in the ground. The capsule 10 is filed partially or completely with the impregnated mix 56 containing nutrients. The container portion 30 is typically filed completely while the distribution portion 32 is partially or completely filed with the impregnated mix 56. Retaining the solution 53 with the solid mix 55 is advantageous as it better retains the nutrients within the capsule 10 over time, forcing the fine root 42 to grow to reach the nutrients.

Whether the solid mix 55 is impregnated with the solution 53 prior or after being placed in the capsule 10 is not really important. However, thereafter, at time intervals, the capsule 10 may be replenished only with another dose of the solution 53. Indeed, the solid mix 55 gets depleted from the solution 53 over time, but the solid mix itself mostly remains in the capsule 10. For example, 500 ml of the solution 53 containing the nutrients is added to the capsule 10 once a year. The solid mix 55 may be changed at longer intervals or as required.

In order to provide the nutrients 16 to the tree 14, the capsule 10 is used in the following manner:
a) the capsule 10 for providing nutrients 16 to the tree is inserted in the ground 12 proximate the tree 14. Capsule 10 is inserted vertically in the grounds 12, closed end 24 first and at a depth so that the open end 26 ends up being proximate to the surface of the ground 12. In other words, the capsule 10 is inserted completely, or almost completely, in the ground 12. If the capsule is 406.4 mm (16 in) high (long), then the hole in the ground in which the capsule 10 is inserted should be approximately, or at least as deep. Capsule 10 should be inserted at a radial distance from the trunk of the tree 14 where the fine roots should be. Typically, this corresponds to approximately right underneath where the tip of the branches are;
b) placing the solid mix 55 in the capsule;
c) placing the nutrients 16, typically diluted in the previously described solution 53, in the container portion 30, thereby impregnating the solid mix 55; and
d) providing roots 18, and particularly the fine roots of the tree 14 access to the nutrients 16 through at least one perforation 38. By inserting the capsule 10 in the ground with the closed end 24 first, the perforation 38 ends up being above the container portion 30. The symbiosis of microbial and fungal activity inside the capsule 10 allows the delivery of nutrients to the tree.
e) Optionally, the solid mix 55 may be re-impregnated with another dose of solution 53.

This method of providing nutrients to a tree improves its health by providing a local environment that is not only rich in nutrients, but where the fungi and microbial elements work in association with the organic and mineral soil to create an artificial rhizosphere that works in symbiosis with the tree. The growth of fine roots 42 is also stimulated by retaining at least some of the nutrients within the capsule 10, thereby forcing the fine roots 42 to grow to reach inside the capsule 10. Because the container portion 30 is provided with the solid container wall 34, the mix at least partially contained therein remains much longer in the ground, more evenly distributing the nutrients over time.

If capsule 10 is provided with one or more thread 46, then the capsule 10 needs to be screwed into the ground 12. Once capsule 10 is screwed or inserted in the ground 12 down until the cover 28 is approximately flush with the ground 12, or a bit below the ground 12, installation is completed.

Once capsule 10 is properly installed in the ground, the container portion 30, with its closed end 24, constitutes a sort of recipient where not only nutrients 16 are placed, but where liquid, typically rainwater 52, accumulates. Because the interior of the capsule 10 is open to the atmosphere at ambient temperature, while the exterior of the capsule 10 is in contact with the ground 12, typically at a slightly different temperature, rainwater 52 contained in the container portion 30 condensates on the interior of the distribution walls 36, creating microscopic droplets 54 of water. The droplets 54, which may carry some nutrients 16, slide along the distribution wall 36 and fall proximate the perforations 38 as well as into the container portion 30 of the capsule 10. These droplets 54 are then absorbed by the soil immediately surrounding capsule 10, thereby attracting the fine roots 42 of the tree 14. Because it is possible for water to accumulate for a while in the container portion 30, it has sufficient time to capture at least a portion of the nutrients 16, which it can then carry to the fine roots 42. This would not be as effective if the container portion 30 was open so that water could not accumulate therein.

A while after installation (for example, after one year), it is necessary to check the status of the content of capsule 10. In order to do so, the cover 28 is unlocked from the body 20 (if it was locked) and removed so as to expose the cavity 22. If required, the cavity 22 may be cleaned from excess fine roots which have reached therein and the container portion 30 may be replenished with new nutrients 16. Such regular maintenance will ensure that the tree 14 is provided with the required nutrients.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description. The invention is defined by the claims that follow.

What is claimed is:

1. A capsule for being inserted in a ground proximate a tree for providing nutrients to the tree through its roots, the capsule comprising:
a hollow body with a closed end and an opposite open end, the hollow body having a container portion proximate the closed end and a distribution portion between the container portion and the open end, the container portion having a solid container wall, the distribution portion having a lateral distribution wall with at least one perforation; and
a cover, the cover being removably connected to the open end for selectively closing the open end,
wherein when the capsule is inserted closed end first in the ground proximate the tree, the container portion is operable to receive the nutrients inserted through the open end, the nutrients being accessible to the roots through the at least one perforation, the cover being operable to close the open end of the hollow body once the nutrients are contained in the container portion thereby preventing removal of the nutrients.

2. The capsule of claim 1, wherein the hollow body is cylindrical.

3. The capsule of claim 1, wherein the hollow body has a height, the container portion extending between 10% and 75% of the height.

4. The capsule of claim 3, wherein the container portion extends between 10% and 50% of the height.

5. The capsule of claim 1, wherein the at least one perforation is fewer than 20 perforations.

6. The capsule of claim 1, wherein a diameter of the at least one perforation is comprised between 7.9 mm ( 7/16 in) and 76.2 mm (3 in).

7. The capsule of claim 1, wherein the cover is lockable to the hollow body.

8. The capsule of claim 7, wherein the cover is provided with an aperture in a top face to let rainwater accumulate in the container portion, the top face being opposite to the closed end when the cover is installed on the hollow cylindrical body.

9. The capsule of claim 2, wherein the closed end is conical.

10. The capsule of claim 2, wherein the hollow body further comprises a thread running at least partially on an exterior of at least one of the solid container wall and the lateral distribution wall.

11. A method of providing nutrients to a tree, the method comprising:
inserting the capsule of claim 1 in a ground proximate the tree so that the closed end is inserted first and so that the open end is proximate a surface of the ground;
placing the nutrients in the container portion; and
providing roots of the tree access to the nutrients through the at least one perforation located in the ground above the container portion.

12. The method of claim 11, further comprising adding a solid mix to the capsule.

13. The method of claim 12, further comprising impregnating the solid mix with the nutrients.

14. The method of claim 13, further comprising, prior to the impregnating, diluting the nutrients with gelatin and humic acid in water, thereby creating a solution.

15. The method of claim 13, further comprising replenishing the container portion with additional nutrients.

16. A method for improving health of a tree planted in a ground, the method comprising:
providing roots of the tree access to nutrients placed in the container portion of the capsule of claim 1 through the at least one aperture, the capsule being inserted in the ground so that the at least one aperture is placed above the container portion.

17. The method of claim 16, further comprising adding a solid mix to the capsule.

18. The method of claim 17, further comprising impregnating the solid mix with the nutrients.

19. The method of claim 18, further comprising, prior to the impregnating, diluting the nutrients with gelatin and humic acid in water, thereby creating a solution.

20. The method of claim 18, further comprising replenishing the container portion with additional nutrients.
